(19) United States
(12) Patent Application Publication
(10) Pub. No.: US 2026/0346190 A1
(43) Pub. Date: Nov. 5, 2026

(54) GAS SEPARATION SYSTEM

(71) Applicant: SAFRAN AEROSYSTEMS, Plaisir (FR)

(72) Inventor: Jo¿l Maillard, Moissy-Cramayel (FR)

(21) Appl. No.: 19/119,882

(22) PCT Filed: Oct. 5, 2023
(86) PCT No.: PCT/FR2023/051541

§ 371 Date: Apr. 10, 2025

(30) Foreign Application Priority Data
Oct. 13, 2022 (FR) FR2210557

(51) Int. Cl. B01D 53/22; B01D 46/00; B01D 53/30; B64D 37/32

(52) U.S. Cl. CPC B01D 53/229; B01D 46/0027; B01D 53/30; B01D 2053/224; B01D 2259/4575; B64D 37/32

(57) ABSTRACT

The invention relates to a gas separation system comprising:
a gas separation unit comprising a body having:
   at least one gas inlet,
   at least one gas outlet, and
   at least one gas separation membrane, capable of being arranged in the body between the gas inlet and the gas outlet; and
a filtering member, capable of being arranged upstream of the gas separation membrane, in particular upstream of the gas separation unit.

Furthermore, the gas separation unit and/or the filtering member comprises at least one sensor of a parameter of the gas passing through the gas separation membrane.

### TECHNICAL FIELD

The invention relates, in general, to the separation of components present within a gas, in particular, to gas separation systems, and more specifically, to the instrumentation integrated into gas separation systems.

More specifically, the invention relates to a gas separation unit, such as an air separation module, and to a gas separation system incorporating such a gas separation unit and allowing the control of parameters, such as temperature, pressure and pollution, that influence the gas separation performance of such a gas separation system.

### PRIOR ART

Gas separation systems that make it possible to separate different components present within a gas are known.

In particular, in the aeronautical field, air separation units, also known by the acronym ASM, are incorporated into systems on board civil or military aircraft to produce nitrogen from air. The nitrogen produced is channelled towards fuel tanks to lower the oxygen level inside them and thus eliminate the risk of explosion.

When an ASM-type air separation unit is used, the separation is achieved using a membrane that is conventionally formed by polymeric hollow fibres encapsulated in a metal tube. The air admitted into the tube passes through the membrane. This results in an oxygen-rich fraction exiting through a first outlet and a nitrogen-rich air fraction exiting through a second outlet.

In addition, the membranes are sensitive to pollution in the injected air. In particular, ozone, volatile organic compounds or even fine particles present in the air are likely to damage the membrane and reduce its performance.

Generally, in this respect, a filtering member is positioned upstream of the ASM-type air separation unit in order to filter the air pollution, in particular fine particles, before conveying the latter to the membrane. Such filtering members may include in particular volatile organic compound (VOC) filters, ozone filters and particle filters, which may be arranged independently of one another or grouped together in a multi-stage unit.

As air separation is optimal at a given pressure and temperature at the membrane, in current gas separation systems which incorporate ASM-type air separation units, pressure and temperature sensors are arranged upstream of the membrane and allow the parameters relating to pressure and temperature to be controlled.

Currently, ASM-type air separation units are considered to be passive devices. The temperature and pressure of the membrane are deduced from measurements upstream of the ASM-type air separation unit, without direct measurement, i.e. inside the membrane.

The measurement of parameters related to temperature and pressure is therefore unreliable and can lead to an erroneous assessment of the condition of the membrane.

In addition, failure to detect that the membrane is being used in unsuitable conditions can lead to premature deterioration.

For these reasons, the filtering elements are regularly changed to ensure that the membrane is not subjected to conditions that could degrade its performance. Similarly, the membranes are also regularly changed as a preventive measure.

Consequently, the filtering elements and the membranes are replaced without taking into account the actual state of degradation of the membrane.

### DISCLOSURE OF THE INVENTION

The invention therefore aims to remedy these disadvantages and to propose a gas separation unit comprising a body having:
at least one gas inlet,
at least one gas outlet, and
at least one gas separation membrane, able to be arranged in the body between the gas inlet and the gas outlet.
   In addition, at least one sensor for a gas parameter passing through the gas separation membrane is integrated into the gas separation unit.

Advantageously, the measuring sensor can be positioned downstream and/or upstream of the gas separation membrane.

The invention also relates to a gas separation system comprising:
a gas separation unit comprising a body having:
   at least one gas inlet,
   at least one gas outlet, and
   at least one gas separation membrane, able to be arranged in the body between the gas inlet and the gas outlet; and
a filtering member, which can be arranged upstream of the gas separation membrane, in particular upstream of the gas separation unit.

In addition, the gas separation unit and/or the filtering member comprises at least one sensor for a parameter of the gas passing through the gas separation membrane.

Advantageously, the sensor integrated into the gas separation unit can be arranged downstream and/or upstream of the gas separation membrane.

According to one feature, the sensor integrated into the filtering member can be arranged downstream and/or upstream of filtration means integrated into the filtering member to ensure the filtration of the gas passing through the gas separation membrane.

Advantageously, the sensor integrated into the gas separation unit and/or the filtering member can be one of the following sensors:
a temperature sensor;
a pressure sensor; and/or
a pollution sensor.

Preferably, the gas separation system comprises at least one electrical interface connector connected to the sensor of the gas separation unit and/or the filtering member, and a management computer connected to the electrical interface connector.

Advantageously, the gas separation unit and/or the filtering member may comprise at least one memory.

According to one feature, the electrical interface connector can be connected to the memory.

Advantageously, a code, configured to determine a duration of operation of the gas separation membrane and/or of the filtering member, can be integrated into the memory chip.

Preferably, the code integrated into the memory is encrypted.

The invention also relates to an aircraft comprising:
at least one gas separation system as described above; and/or
at least one gas separation unit as described above.

Of course the various features, alternatives and/or embodiments of the present invention can be associated with each other according to various combinations insofar as they are not incompatible or exclusive of each other.

### BRIEF DESCRIPTION OF THE DRAWINGS

The present invention will be better understood and other aims, advantages and features will emerge from the detailed description below including embodiments given for purely illustrative purposes and with reference to the accompanying drawings, presented as non-limiting examples, which may be used to add to the understanding of the invention and the explanation of its realisation and, where appropriate, contribute to its definition, in which:

FIG. 1 is a schematic cross-sectional view of a gas separation system according to a first embodiment of the invention;

FIG. 2 is a schematic cross-sectional view of a gas separation system according to a second embodiment of the invention; and

FIG. 3 is a schematic cross-sectional view of a gas separation system according to a third embodiment of the invention.

It should be noted that, in the figures, the structural and/or functional elements common to the different embodiments may have the same reference signs. Thus, unless stated otherwise, such elements have identical structural, dimensional and material properties.

In the following description of the invention, the expression ‘at least one’ needs to be considered as equivalent to the expression ‘one or more’.

Similarly, the terms ‘downstream’ and ‘upstream’ characterise the position of one element in relation to another, according to the direction of gas flow in the gas separation system.

### DETAILED DESCRIPTION OF ONE EMBODIMENT

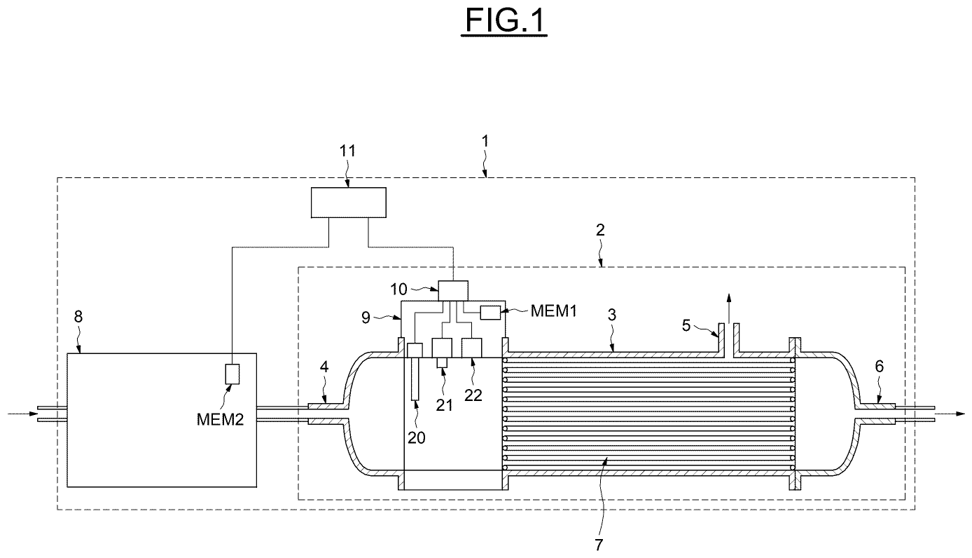

FIG. 1 shows a schematic cross-sectional view of a gas separation system 1 according to a first embodiment of the invention comprising a gas separation unit 2.

In the first embodiment of the invention, the gas separation unit 2 comprises a body 3 with at least one gas inlet 4 and at least one gas outlet. For example, the body 3 is a metal tubular body.

According to the specific example illustrated in FIG. 1, the body 3 of the gas separation unit 2 advantageously includes at least two gas outlets, a first gas outlet 5 and a second outlet 6 respectively. However, the number of gas outlets can be adapted according to the number of components of gas to be separated.

In particular, the first gas outlet 5 is intended for the extraction of nitrogen-enriched air and the second outlet 6 is intended for the extraction of nitrogen-depleted air.

One or more gas separation membranes 7 are arranged in the body 3 of the gas separation unit 2 between the gas inlet 4 and the gas outlet, in particular between the gas inlet 4 on the one hand and the first gas outlet 5 and the second outlet 6 on the other hand. The gas separation membranes 7 are intended to separate the gas that passes through them. The gas separation membranes 7 are held in the body 3 between the gas inlet 4 and the gas outlet, in particular the first gas outlet 5 and the second gas outlet 6. In particular, the gas separation unit 2 illustrated in FIG. 1 includes a single gas separation membrane 7.

In the example shown, the gas passing through the gas separation membrane 7 is air.

The gas separation membrane 7 can be formed by a plurality of hollow fibres, in particular a plurality of polymeric hollow fibres, preferably encapsulated within the body 3 of the gas separation unit 2.

Furthermore, according to the first embodiment illustrated in FIG. 1, at least one sensor is incorporated into the gas separation unit 2. The sensor is able to measure a parameter of the gas intended to pass through the gas separation membrane 7.

More specifically, in the example illustrated in FIG. 1, the gas separation unit 2 comprises a temperature sensor 20 and a pressure sensor 21.

As the gas separation membrane 7 functions optimally at a given temperature and pressure, the temperature sensor 20 and the pressure sensor 21 make it possible to determine a temperature T and a pressure P within the gas separation unit 2, in particular within the gas separation membrane 7.

Furthermore, since the gas separation membrane 7, in particular the polymer fibres, is sensitive to the pollution in the air passing through it, such as ozone, volatile organic compounds, fine particles, etc., the lifespan of the gas separation membrane 7 is affected by the pollution of the air.

In the aeronautical field, the level of air pollution in which an aircraft can fly is heavily dependent on the geographical area and the operating conditions. The level of air pollution can therefore vary, fluctuate and reach a critical level for the proper functioning of the gas separation unit 2 and the lifespan of the gas separation membrane 7.

In this respect, in the example illustrated in FIG. 1, the gas separation system 1 includes a filtering member 8, arranged upstream of the gas separation membrane 7, in particular upstream of the gas separation unit 2.

Preferably, the filtering member 8 is configured to filter fine particles, ozone and volatile organic compounds from the gas entering the gas separation system 1 and intended to pass through the gas separation membrane 7.

In a particularly advantageous manner, the gas separation unit 2 also comprises a pollution sensor 22. In particular, the pollution sensor 22 is integrated into the gas separation unit 2. The pollution sensor 22 makes it possible to determine a pollution level Pol of the gas passing through the gas separation membrane 7.

The presence of the temperature sensor 20, the pressure sensor 21 and/or the pollution sensor 22 makes it possible to measure the temperature T, the pressure P and the pollution level Pol of the gas passing through the gas separation membrane 7 and to enable these parameters to be monitored in real time, occasionally or continuously. It is thus possible to regulate these parameters with a view to optimising the operation of the gas separation membrane 7.

The monitoring of the parameters relating to the temperature T, pressure P and pollution level Pol of the gas passing through the gas separation membrane 7 also makes it possible to consider the predictive maintenance of the gas separation system 1. In particular, it is thus possible to consider replacing the gas separation membrane 7 and/or the filtering member 8 as and when necessary, i.e. when the gas separation membrane 7 and/or the filtering member 8 have lost their observed capacity and their efficiency is no longer sufficient to ensure optimal gas separation.

Preferably, the temperature sensor 20, the pressure sensor 21 and/or the pollution sensor 22, advantageously arranged in the gas separation unit 2, are positioned upstream of the gas separation membrane 7 in order to determine the parameters of the gas intended to pass through it, in particular the temperature T, the pressure P and/or the pollution level Pol of the gas intended to pass through the gas separation membrane 7.

Advantageously, the temperature sensor 20, the pressure sensor 21 and/or the pollution sensor 22 are arranged directly upstream of the gas separation membrane 7. Such an arrangement makes it possible to increase the reliability of the control of the gas parameters as close as possible to the gas separation membrane 7 through which the gas is intended to pass, just before entry into the gas separation membrane 7.

According to an alternative embodiment, the temperature sensor 20, the pressure sensor 21 and/or the pollution sensor 22 can be positioned in a housing 9, in particular a first housing 9, preferably arranged between the gas inlet 4 of the gas separation unit 2 and the inlet of the gas separation membrane 7.

In addition, a temperature sensor, a pressure sensor and/or a pollution sensor may be integrated into the gas separation unit 2 directly downstream of the gas separation membrane 7, i.e. at an outlet of the gas separation membrane 7. Such an additional arrangement makes it possible to determine the temperature, pressure and pollution level of the gas after it has passed through the gas separation membrane 7. It is thus possible to estimate the efficiency and performance of the gas separation membrane 7 and/or the filtering member 8, in particular by differential measurement of the parameters relating to the temperature, pressure and pollution level of the gas.

In the example shown in FIG. 1, the gas separation unit 2 can also include a memory MEM1, in particular a first memory MEM1.

The first memory MEM1 of the gas separation unit 2 can be arranged in the housing 9 in which the temperature sensor 20, the pressure sensor 21 and/or the pollution sensor 22 are positioned.

Preferably, the first memory MEM1 is, for example, a non-volatile memory and is used to store the data collected by the temperature sensor 20, the pressure sensor 21 and/or the pollution sensor 22 of the gas separation unit 2. Furthermore, the first memory MEM1 of the gas separation unit 2 is able to store data relating to the flight and/or usage conditions, to the identification and to the flight phases of the aircraft on which the gas separation unit 2 is mounted. Furthermore, the first memory, MEM1, is also able to store all other data relating to the aircraft on which the gas separation unit 2 is mounted, transmitted via an on-board avionics system.

The MEM1 memory of the gas separation unit 2 makes it possible to record, store and/or consult changes in the parameters measured by the temperature sensor 20, the pressure sensor 21 and/or the pollution sensor 22.

By consulting the data stored in the first memory MEM1, it is possible to characterise the stresses exerted on the gas separation membrane 7 and the conditions of use of the latter.

The monitoring makes it possible to determine any abnormal stresses on the gas separation membrane 7, which could cause it to become defective during its life cycle. This may be the case, in particular, when a gas separation unit 2 that has been detected as defective is put back into use after servicing.

It is thus possible to validate or revoke returns of the gas separation unit 2 under warranty according to the determined operating conditions.

Of course, other measurement sensors may be provided, as a substitute for or in addition to the temperature sensor 20, the pressure sensor 21 and/or the pollution sensor 22, suitable for measuring other parameters within the gas separation membrane 7 and characteristic quantities of the gas passing through it.

In the example shown, the gas separation system 1 also comprises an electrical interface connector 10, in particular a first electrical interface connector 10, connected to the temperature sensor 20, the pressure sensor 21 and the pollution sensor 22 and to the first memory MEM1 of the gas separation unit 2.

Furthermore, the gas separation system 1 comprises a management computer 11 connected to the electrical interface connector 10.

Preferably, a code configured to determine an operating time of the gas separation membrane 7 is integrated into the first memory MEM1 of the gas separation unit 2.

The filtering member 8 can also incorporate a memory MEM2, in particular a second memory MEM2. Preferably, the second memory MEM2 is, for example, a non-volatile memory, and is advantageously connected to the management computer 11.

Preferably, a code configured to determine an operating time of the filtering member 8 is integrated into the memory MEM2 of the filtering member 8.

Advantageously, the code integrated into the first memory MEM1 of the gas separation unit 2 is encrypted. Thus, such an encrypted code makes it possible to certify the authenticity of the gas separation unit 2, and more particularly the gas separation membrane 7, against counterfeits. In addition, such an encrypted code strengthens the security and integrity of the gas separation system 1.

The second MEM2 memory of the filtering member 8 is advantageously connected to the management computer 11.

Advantageously, the code integrated into the second memory MEM2 of the filtering member 8 is encrypted. Thus, such an encrypted code makes it possible to certify the authenticity of the air separation unit 2, and more particularly the filtering member 8, against counterfeits. In addition, such an encrypted code makes it possible to strengthen the security and integrity of the gas separation system 1.

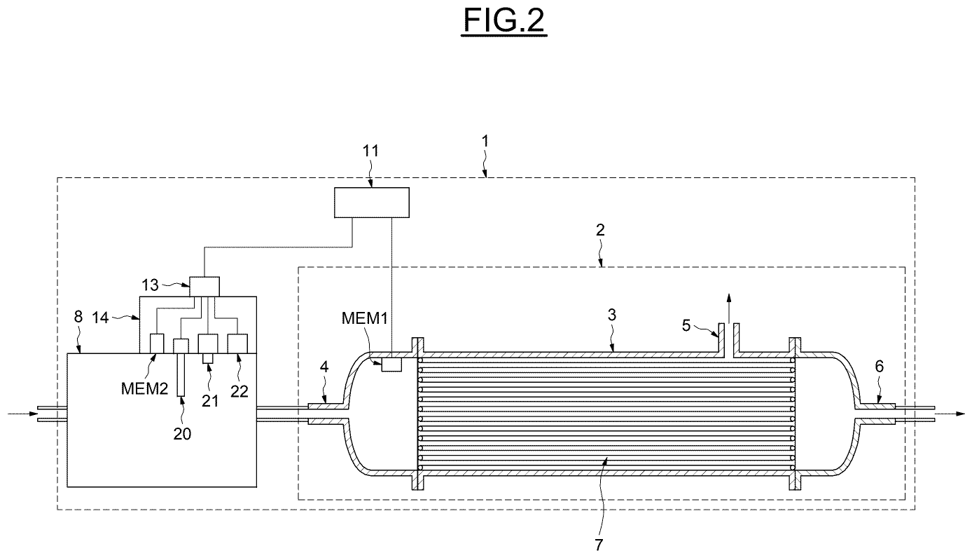

FIG. 2 is a schematic cross-sectional view illustrating a second embodiment of a gas separation system 1. The second embodiment differs from the first embodiment illustrated in FIG. 1 by a different positioning of the temperature sensor 20, the pressure sensor 21 and/or the pollution sensor 22.

Thus, in the second embodiment, at least one sensor is incorporated into the filtering member 8. The sensor is able to measure a parameter of the gas intended to pass through the gas separation membrane 7.

More specifically, in the example shown in FIG. 2, the filtering member 8 includes a temperature sensor 20, a pressure sensor 21 and/or a pollution sensor 22 positioned in the filtering member 8.

From the filtering member 8 incorporating the temperature sensor 20, the pressure sensor 21 and/or the pollution sensor 22, it is thus possible to provide a gas separation system 1 incorporating a conventional air separation unit but which is adapted to control the parameters of the gas passing through the gas separation membrane 7.

In the second embodiment, an electrical interface connector 13, in particular a second electrical interface connector 13, connects the temperature sensor 20, the pressure sensor 21 and/or the pollution sensor 22 to the management computer 11.

Advantageously, the temperature sensor 20, the pressure sensor 21 and/or the pollution sensor 22 integrated into the filtering member 8 are arranged at the outlet of the filtering member 8 in order to characterise the gas intended to pass through the gas separation membrane 7 after filtration.

Thus, preferably, the temperature sensor 20, the pressure sensor 21 and/or the pollution sensor 22 are arranged in the filtering member 8 and downstream of filtration means, not shown in FIG. 2, integrated into the filtering member 8 to ensure filtration of the gas intended to pass through the gas separation membrane 7.

The temperature sensor 20, the pressure sensor 21 and/or the pollution sensor 22 integrated into the filtering member 8 can be positioned in a housing 14, in particular a second housing 14.

In the second embodiment, the first memory MEM1 of the air separation unit 2 can be arranged in or on the gas separation unit 2 or in the second housing 14 and is suitable for direct connection to the management computer 11.

In addition, the second memory MEM2 of the filtering member 8 can be connected to the electrical interface connector 13.

The memory MEM2 of the filtering member 8 can be positioned in the housing 14.

Alternatively, it is also possible that the sensors, such as temperature sensors 20 and pressure sensors 21 integrated into the filtering member 8, are arranged at the inlet of the filtering member 8, in particular upstream of the filtration means, not shown in FIG. 2, integrated into the filtering member 8 to ensure filtration of the gas intended to pass through the gas separation membrane 7.

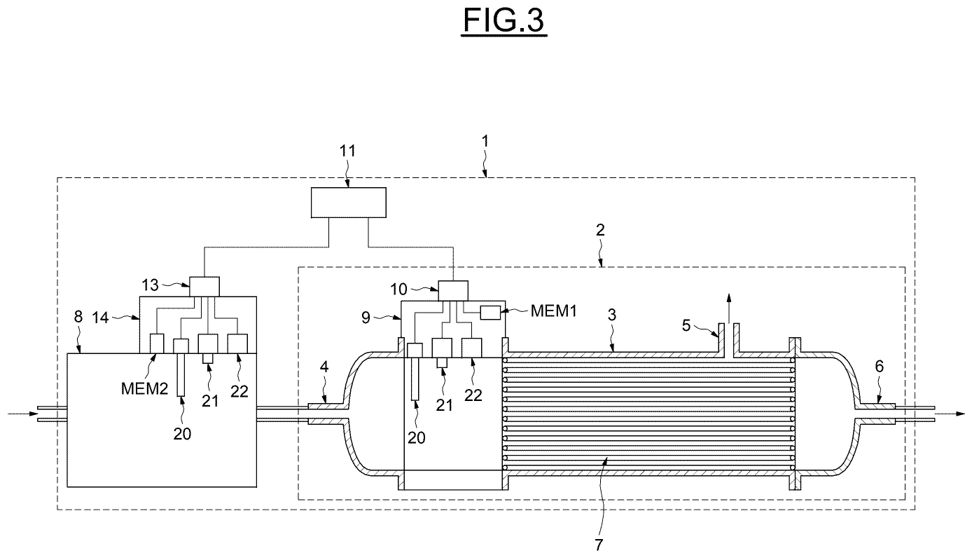

FIG. 3 is a schematic cross-sectional view of a third embodiment of the gas separation system 1, combining both the filtering member 8, similar to that described in relation to the second embodiment, and the gas separation unit 2, similar to that described in relation to the first embodiment.

Thus, according to the third embodiment of the gas separation system 1, the filtering member 8 incorporates a temperature sensor 20, a pressure sensor 21 and/or a pollution sensor 22, in particular a first temperature sensor 20, a first pressure sensor 21 and/or a first pollution sensor 22.

Similarly, in this same third embodiment of the gas separation system 1, the gas separation unit 2 also incorporates a temperature sensor 20, a pressure sensor 21 and/or a pollution sensor 22, in particular a second temperature sensor 20, a second pressure sensor 21 and/or a second pollution sensor 22.

According to the third embodiment of the gas separation system 1, the first temperature sensor 20 and the second temperature sensor 20 may be identical or different, the first pressure sensor 21 and the second pressure sensor 21 may be identical or different, and the first pollution sensor 22 and the second pollution sensor 22 may be identical or different.

The integration of sensors for measuring gas parameters, such as the temperature sensor 20, the pressure sensor 21 and/or the pollution sensor 22, passing through the gas separation membrane 7, makes it possible to optimise the operating point of the gas separation membrane 7, in particular in terms of temperature, pressure and pollution level. It is thus possible to optimise the performance of the gas separation membrane 7 by direct measurement of the parameters.

The gas separation system 1 makes it possible to adapt the replacement of the filtering member 8 and the gas separation membrane 7 to what is strictly necessary according to the observed degradation of performance.

In the examples shown, the gas separation system 1 is an aircraft air separation system and the gas separation unit 2 is an ASM-type air separation unit designed to produce nitrogen from the air passing through the gas separation system 1.

Alternatively, it is possible that gas separation system 1 incorporates all types of gas separation membranes 7.

Thus, the invention also finds an application in units for the treatment of gas mixtures, such as pressure swing adsorption units, also known by the acronym APM for ‘Air Preparation Modules’ or by the acronym PSA for ‘Pressure Swing Adsorption’, which are incorporated into systems on board civil or military aircraft, to enable the separation of gas mixtures by the adsorption of a gas by a solid or a liquid at a given pressure, then by the desorption of the latter at a lower pressure.

Furthermore, the invention can also be used in on-board oxygen generation systems, also referred to by the acronym OBOGS for ‘OnBoard Oxygen Gas Generation System’, which are supplied with air from a compressor of one or more of the engines.

Finally, the invention also can also be used in on-board oxygen generator systems that may include a molecular sieve oxygen generation system, also referred to by the acronym MSOGS for ‘Molecular Sieve Oxygen Generating System’, arranged to provide oxygen-enriched air of a desired oxygen concentration value by adsorbing nitrogen from the air supplied to the system.

In the detailed presentation of the invention given above, the terms used should not be interpreted as limiting the invention to the embodiments disclosed in the description given, but should be interpreted to include all equivalents that can be foreseen by a person skilled in the art by applying their general knowledge to the implementation of the teaching that has just been disclosed to them.

Of course, the invention is not limited to the embodiments described above and provided only as example. It covers various modifications, alternative forms and other variants that a person skilled in the art could envisage in the context of the present invention and in particular any combinations of the various operating modes described above, which can be taken separately or in association.

1. Gas separation unit comprising a body having:
at least one gas inlet;
at least one gas outlet; and
at least one gas separation membrane, which can be arranged in the body between the gas inlet and the gas outlet;
wherein at least one sensor of a parameter of the gas passing through the gas separation membrane is integrated into the gas separation unit.

2. Unit according to claim 1, in which the measuring sensor is positioned downstream and/or upstream of the gas separation membrane.

3. Gas separation system comprising:
a gas separation unit comprising a body having:
at least one gas inlet;
at least one gas outlet; and
at least one gas separation membrane, capable of being arranged in the body between the gas inlet and the gas outlet; and
a filtering member, able to be arranged upstream of the gas separation membrane,
wherein the gas separation unit and/or the filtering member comprises at least one sensor of a parameter of the gas passing through the gas separation membrane.

4. Gas separation system according to claim 3, wherein the sensor integrated into the gas separation unit is arranged downstream and/or upstream of the gas separation membrane.

5. Gas separation system according to claim 3, wherein the sensor integrated into the filtering member is arranged downstream and/or upstream of filtration means integrated into the filtering member to ensure filtration of the gas intended to pass through the gas separation membrane.

6. Gas separation system according to claim 3, wherein the sensor integrated into the gas separation unit and/or the filtering member is one of the following sensors:
a temperature sensor;
a pressure sensor; and/or
a pollution sensor.

7. Gas separation system according to claim 3, further comprising at least one electrical interface connector connected to the sensor of the gas separation unit and/or of the filtering member, and a management computer connected to the electrical interface connector.

8. Gas separation system according to claim 3, wherein the gas separation unit and/or the filtering member comprises at least one memory.

9. Gas separation system according to claim 7, wherein the electrical interface connector is connected to the memory.

10. Gas separation system according to claim 8, wherein a code, configured to determine an operating time of the gas separation membrane and/or the filtering member, is integrated into the memory chip.

11. Gas separation system according to claim 10, wherein the code integrated in the memory is encrypted.

12. Aircraft comprising:
at least one gas separation system comprising:
a gas separation unit comprising a body having:
at least one gas inlet;
at least one gas outlet; and
at least one gas separation membrane, capable of being arranged in the body between the gas inlet and the gas outlet; and
a filtering member, able to be arranged upstream of the gas separation membrane, wherein the gas separation unit and/or the filtering member comprises at least one sensor of a parameter of the gas passing through the gas separation membrane; and/or
at least one gas separation unit according to claim 1.
